(19) United States
(12) Patent Application Publication
(10) Pub. No.: US 2011/0179834 A1
(43) Pub. Date: Jul. 28, 2011

(54) SECURITY APPARATUS INCLUDING BREAKAWAY KEY

(75) Inventors: Robert Mahaffey, Vancouver (CA); John Hung, Vancouver (CA); Wilson Tse, Burnaby (CA)

(73) Assignee: ACCO Brands Corporation, Lincolnshire, IL (US)

(21) Appl. No.: 12/915,472

(22) Filed: Oct. 29, 2010

Related U.S. Application Data
(60) Provisional application No. 61/298,044, filed on Jan. 25, 2010.

(51) Int. Cl. E05B 73/00; E05B 35/00

(52) U.S. Cl. 70/58; 70/344

(57) ABSTRACT

A security system is disclosed. The security system may include a breakaway key and security apparatus. The breakaway key may have one or more stress areas, to facilitate separation of the key when it is improperly used. The security apparatus may have a rotatable sleeve, so that a user attempting to twist the security apparatus will only end up twisting the sleeve. Thus, the security apparatus cannot easily be broken by a rotation.

### CROSS-REFERENCES TO RELATED APPLICATIONS

This patent application is a non-provisional of and claims priority to U.S. provisional patent application No. 61/298,044, filed on Jan. 25, 2010, which is herein incorporated by reference in its entirety for all purposes.

### BACKGROUND

A number of tubular locks are known. One type of tubular lock can be used to secure portable electronic devices, such as laptop computers. The tubular lock may have an engagement element that is secured to a security slot of the laptop computer. However, such tubular locks are often large and require high strength materials, to increase the locking strength and prevent unauthorized users from breaking the locks. This will also result in increased costs for the locks. Also, unauthorized users may twist the tubular lock, to break either the engagement element or a portion of a housing of the laptop computer.

Embodiments of the invention address these and other problems, individually and collectively.

### BRIEF SUMMARY

Embodiments of the invention are directed to security apparatuses, as well as systems and methods for using such physical security apparatuses.

One embodiment is directed to a security system comprising a security apparatus and a key. The security apparatus has a housing and an engagement element extending out of a first side of the housing. The key is configured to lock the security apparatus, and has a key barrel, a key flag, and at least one stress area formed in the key between the key barrel and the key flag.

Another embodiment is directed to a key for locking and unlocking an associated security apparatus, the key having a key body comprising a key barrel, a key flag, and at least one stress area formed in the key such that the key barrel is configured to break away from the key flag upon application of a minimum torque to the key.

Another embodiment is directed to a method of securing a portable article. The method comprises obtaining a security apparatus having a housing and an engagement element extending out of a first side of the housing. The method further includes inserting at least a portion of the engagement element into an aperture in a portable article, inserting a key into the security apparatus, the key having a key barrel, a key flag, and at least one stress area formed in the key between the key barrel and the key flag, and locking the security apparatus with the key.

These and other embodiments of the invention are described in further detail below with reference to the Figures and the Detailed Description.

### BRIEF DESCRIPTION OF THE DRAWINGS

FIG. 1 shows a top view of a locked security system, according to an embodiment.

FIGS. 2A-2B show various views of an embodiment of a security system. A portion of a housing portion is also shown.

FIGS. 3A-3C show an embodiment of a key.

FIG. 4 shows a front view of an embodiment of a security apparatus. A portion of the apparatus barrel is removed for illustrative purposes.

FIG. 5 shows an exploded view of a security system according to an embodiment of the invention.

FIG. 6 shows a secured portable electronic device according to an embodiment of the invention.

In the Figures, like numerals designate like elements, and the descriptions of like elements may not be repeated in some instances.

### DETAILED DESCRIPTION

Embodiments of the invention are directed to security apparatuses, methods for using security apparatuses, and systems using such security apparatuses. The security apparatuses can be used to prevent or deter the theft of portable articles.

One embodiment of a security system may comprise a security apparatus and a key configured to lock the security apparatus. The security apparatus may have a housing, an engagement element extending out of a first side of the housing, and a rotatable sleeve surrounding at least a portion of the housing. The key may have a key barrel, a key flag, and at least one stress area formed in the key between the key barrel and the key flag.

The portable article to be secured may comprise an aperture, and the aperture may be a through aperture or a blind aperture. The aperture may be formed in a housing associated with the portable article. Further, the aperture may have any suitable dimensions or geometry. For example, the aperture may have dimensions of about 3 mm by about 7 mm, and may have a generally rectangular in shape. In other embodiments, the aperture may be in the form of a round hole that has dimensions less than about 5 mm.

Alternatively or additionally, the portable article may include a lock interface member, and the lock interface member may comprise the aperture. The lock interface member may be used to enhance security and may improve the strength of the coupling between the portable article and the security apparatus. The lock interface member may be an attachment that may be attached to the housing of the portable article, or it may be integrally formed in the housing. For example, in some embodiments, the lock interface member may be operatively or physically coupled to the chassis of the portable article and/or may be operatively or electrically coupled to some electrical component in the portable article. Exemplary lock interface members are described in U.S. patent application Ser. Nos. 12/446,560, 12/446,556, and 12/446,568, which all entered U.S. national phase on Apr. 21, 2009, and which are herein incorporated by reference in their entirety for all purposes. Exemplary lock interface members are also described in U.S. patent application Ser. Nos. 12/599,838 and 12/599,844, which both entered U.S. national phase on Nov. 12, 2009, and which are herein incorporated by reference in their entirety for all purposes.

A security apparatus according to an embodiment of the invention may comprise a head and a security device. The head and the security device may be physically and/or operationally coupled together.

The security device may comprise a cable, or some other type of device to provide security. If the security device comprises a cable, then the cable may be secured to an object other than the portable article, such as an immovable object. The immovable object can comprise objects such as a desk or cabinet so that a portable article coupled to the cable cannot be removed. In another embodiment, the security device may comprise a wireless device such as a wireless transmitter and/or receiver. The wireless device may be used in a proximity detection system or a motion detection system. For example, a motion detector could present in the wireless device so that when the motion detector moves, an associated alarm is triggered. The alarm may be in the security device or may be external to the security device. In another embodiment, there may be a base device associated with the wireless device, and these components may be used in a proximity detection system. Wireless signals may be transmitted between the security device and the base device, and when these devices are separated by a predetermined length, an associated alarm (e.g., an audible alarm) may be triggered. The alarm could be in the base device or in the security device.

The head may be a locking head. A locking head according to an embodiment of the invention may comprise a locking mechanism such as a key locking mechanism or a combination locking mechanism disposed within it. For example, an engagement element may extend out one axial side (a first side) of the locking head, and a second axial side opposite the first axial side may comprise a combination for the combination lock.

The portable article that is to be secured may comprise any suitable article, such as a portable device (e.g., a portable electronic device). Examples of such articles comprise portable computers such laptop, tablet, desktop, and server computers, flat panel televisions, projectors, monitors, portable music players, printers, external hard-drives, cell phones, etc. Other types of articles may include medical devices that may or may not have electronics in them, industrial devices such as power or pneumatic tools, or sporting goods (bicycles, golf equipment such as golf bags, hockey equipment, etc.). In exemplary embodiments, the portable article that is to be secured may be a hand-carried article (i.e., an article capable of carried by a typical user without assistance).

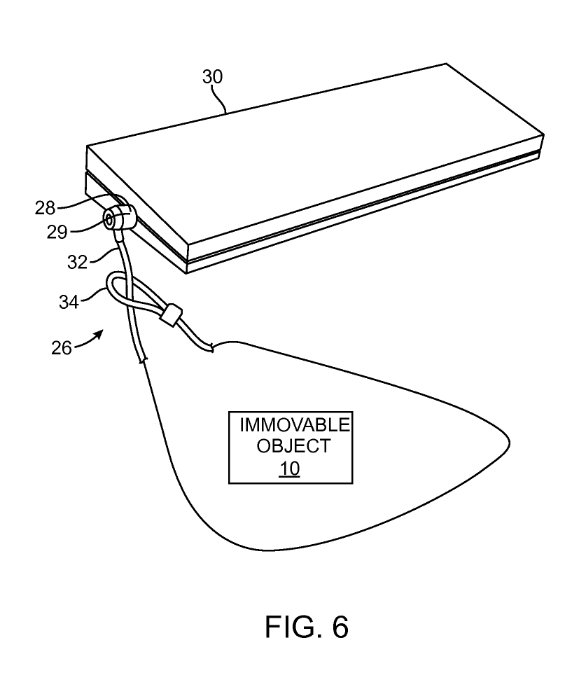

FIG. 6 shows a system comprising a portable article 30 and an embodiment of a security apparatus 26 that is used to secure the portable article 30 to an immovable object 10 such as a desk leg or the like. Thus, the security apparatus 26 is secured to the portable article 30. The security apparatus 26 comprises a head 28 having a rotatable sleeve 29 and a cable 32 coupled to the head, which may be a locking head in this example. In the embodiment of FIG. 6, cable 32 is connected to a security device at a second end (e.g., near the key end) of the head 28, opposite from the engagement element (not shown). A loop 34 is at a terminal end of the head 28. The cable 32 may comprise a strong material such as stainless steel or Kevlar™.

To secure the portable article 30 to the immovable object, the cable 32 may be wrapped around the immovable object and the head 28 may pass through the loop 34. An engagement element in the head 28 may then be inserted into an aperture in the portable article 30, or in an aperture in a lock interface member that is associated with the portable article 30. A stabilizing element (such as an anti-rotation pin) may be inserted into the aperture in the lock interface member to stabilize the head 28 so that the engagement element cannot be readily withdrawn from the aperture. A locking mechanism such as a key locking mechanism or a combination locking mechanism may be used to keep the stabilizing element and/or the engagement element from moving or not moving.

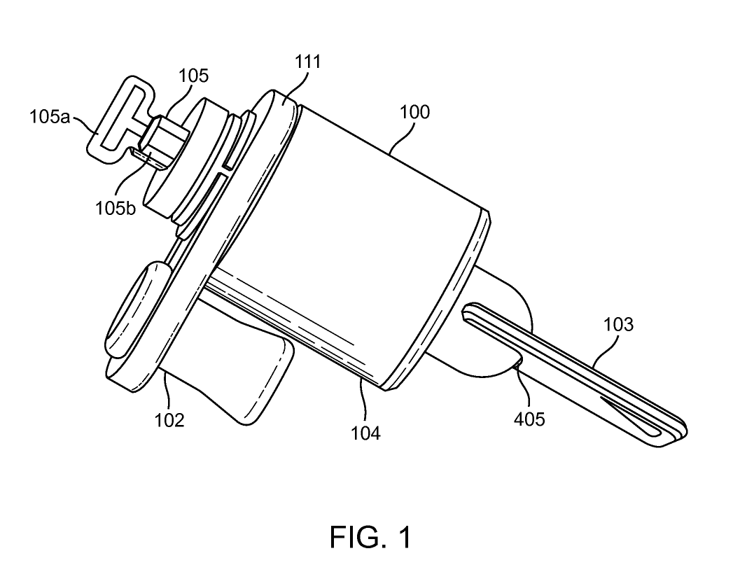

Other specific security apparatus embodiments are shown in FIGS. 1-5.

FIG. 1 shows a close up view of parts of a security apparatus according to an embodiment of the invention. As shown in FIG. 1, a key 103 is disposed within the security apparatus. In one example, the key may be a breakaway key (e.g., the key 103 may have one or more stress areas 405) as described in more detail below. Referring to FIG. 1, a security system according to an embodiment of the invention may comprise a key 103 and a security apparatus (e.g., a lock). The security apparatus may, in turn, comprise a head 100 and a security device 102. The head 100 and the security device 102 may be physically and/or operationally coupled together. In the embodiment of FIG. 1, the security device 102 can be coupled to the head 100 between an engagement element 105 and a rotatable sleeve 104 of the head 100. That is, the security device 102 can be coupled to a cable ring 111. The cable ring 111 may be located between the rotatable sleeve 104 and the first side of the head 100. An engagement element 105 can protrude from the first side of the housing of the head 100. The engagement element 105 can comprise a T-bar 105a, and there can also be one or more anti-rotation pins 105b. Other embodiments contemplate the security device 102 coupled to the head 100 in other locations.

The head 100 may be a locking head. A locking head according to an embodiment of the invention may comprise a locking mechanism such as a key locking mechanism or a combination locking mechanism disposed within it. FIG. 1 shows an embodiment of a key locking mechanism, with a key 103 disposed within the security apparatus. In one example, the key may be a breakaway key as described in more detail below. In the embodiment of FIG. 1, the security device 102 can be coupled to the head 1 between an engagement element 105 (e.g., the engagement end of locking head 100) and a rotatable sleeve 104 of the head 100. Other embodiments contemplate the security device 102 coupled to the head 100 in other locations.

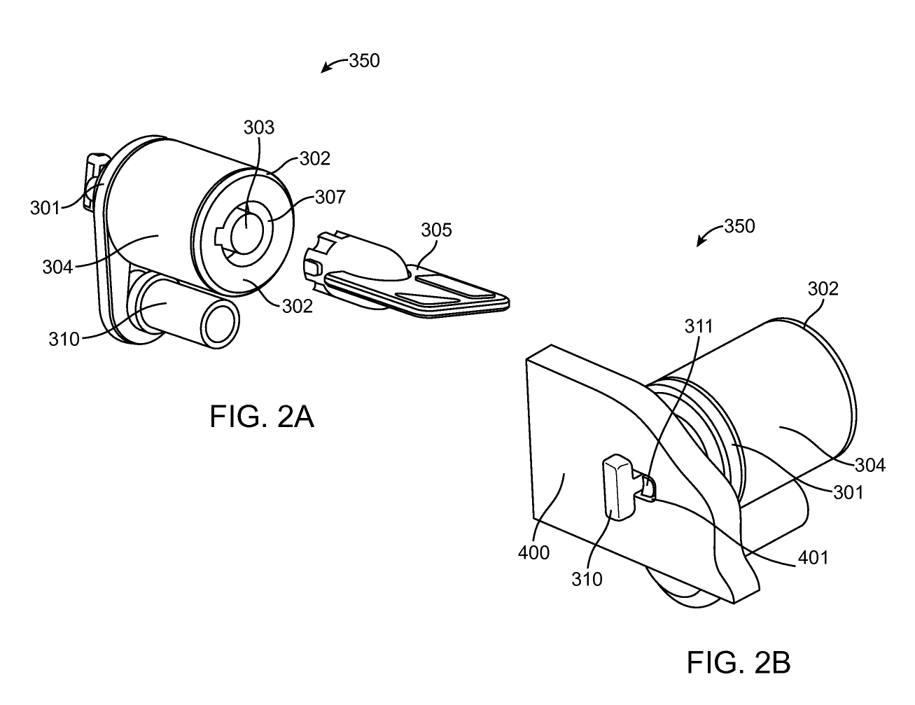

FIGS. 2A-2B show different perspective views of a security system according to an embodiment of the invention. FIG. 2A shows a locked security system. The security system may include a security apparatus 350, a key 305 that is associated with the security apparatus 350, and a portable article. The security apparatus 350 may comprise a locking head 301 and a security device 310. In FIG. 2A, a portable article is not shown for clarity. FIG. 2B shows the security system attached to a housing 400. The housing 400 may be a wall or part of the housing of a portable article (not shown) or a portion of a lock interface member associated with the portable article, such as a portable electronic device. FIG. 2B shows only a portion of a wall of the portable article 400, for clarity of illustration. The housing 400 may comprise an aperture 401 which may be in the form of a slot that has sides with dimensions of about 3 mm by about 7 mm. Such small security slots do not significantly alter the aesthetic appearance of portable electronic devices, but can be used to deter theft. For example, if a thief tries to separate a “locked” locking head from a portable electronic device, the portable electronic device will be damaged, possibly irreparably, thereby impairing its value.

In exemplary embodiments, the locking head 301 can have an outer portion comprising a lock housing 302, and an inner portion comprising an inner cylinder 303. A space 307 can be formed between housing 302 and inner cylinder 303, into which the key 305 can be inserted in order to secure the locking head 301. The space 307 may contain one or more pins as part of a locking component. As used herein, a “locking component” may comprise one or more structures suitable for causing the head to be in locked and unlocked configurations (i.e., locked or unlocked states). In certain embodiments, the space 307 may contain seven pins. Other embodiments contemplate other amounts of pins, such as 4, 5, 6, 8, etc.

100311 A rotatable sleeve 304 can surround at least a portion of the housing 302. For example, in the embodiment of FIGS. 2A-2B, the rotatable sleeve 304 surrounds almost all of the housing 302, except for a small lip of the housing material. In other examples, the rotatable sleeve 304 can surround all of the housing 302, or smaller portions of the housing 302. The rotatable sleeve 304 may be configured to rotate freely about the housing 302. Thus, if a user tries to grab the lock by hand or with tools (e.g., pliers, vice grips, etc.) the rotatable sleeve 304 will rotate around the housing 302, and not allow torque to be transferred to the lock (i.e., the housing 302 will not itself rotate). The rotatable sleeve 304 may comprise a slip ring or other suitable revolving shell.

In certain embodiments, the rotatable sleeve may use ball bearings, grease, or other lubricating methods. In other embodiments, the rotatable sleeve 304 may be configured to be large enough compared to the housing 302, such that the rotatable sleeve 304 can freely rotate about housing 302 without lubrication. The rotatable sleeve 304 may comprise plastic, metal, or other suitable materials or combination of materials. In an exemplary embodiment, the rotatable sleeve 304 may comprise an injection molded plastic slip ring. In the embodiment shown in FIGS. 2A-2B, the rotatable sleeve 304 surrounds substantially all of the housing 302, such that a person will not be able to hold (such as with their hand) any portion of the housing 302 without also touching the rotatable sleeve 304. If a person attempts to twist the locking head 301, the user's hand will rotate instead of the lock. This can prevent the person from twisting the housing to break the locking head 301, as described herein.

The locking head 301 may have an engagement element 310 and one or more (e.g. 2, 3, etc.) stabilizing elements 311 extending out of a first side of a lock housing 302. In the embodiment of FIGS. 2A-2B, stabilizing elements 311 comprise a first stabilizing element and a second stabilizing element (not shown), that are on opposite sides of the engagement element 310. In exemplary embodiments, the first stabilizing element and the second stabilizing element comprise a first anti-rotation pin and a second anti-rotation pin. The engagement element 310 and stabilizing elements 311 may be inserted into the aperture 401 of the housing 400. The security apparatus 350 in FIG. 2B is in the “locked” position, such that it is engaged with the aperture 401 in the housing 400. The anti-rotation pins may prevent rotation of the security apparatus while engaged to the portable article, preventing unauthorized removal.

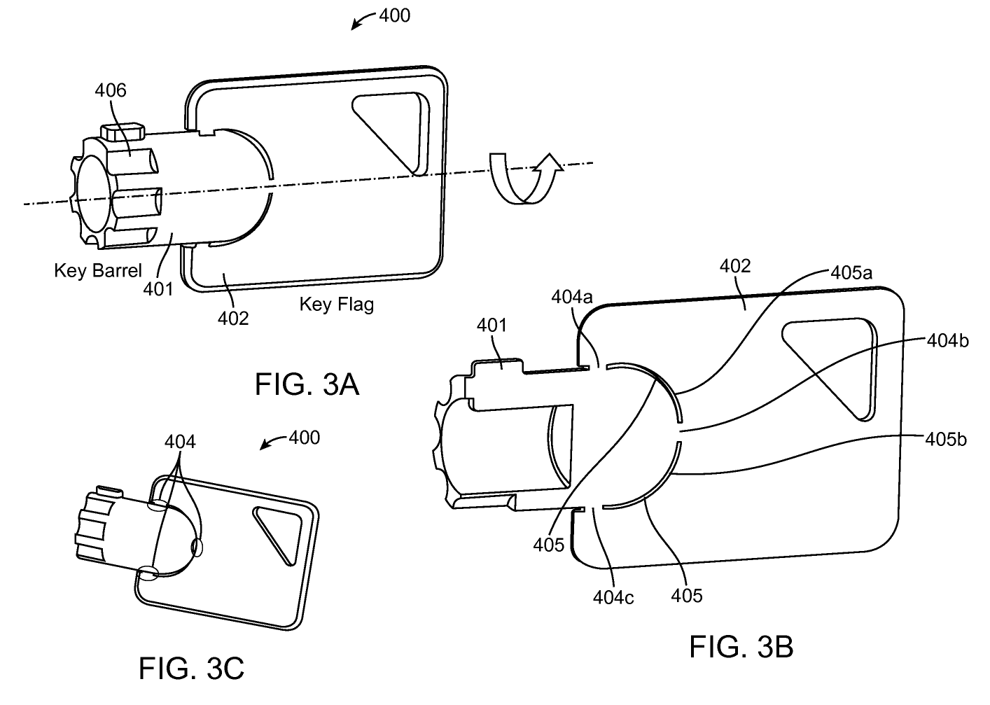

FIGS. 3A-3C show views of a key according to embodiment of the invention. FIGS. 3A and 3C show angled views of the key 400, and FIG. 3B shows a cutaway view of a key 400, to highlight the connection between the key barrel 401 and the key flag 402. The key 400 can be used with the security apparatus shown in FIG. 2, or in other suitable security apparatuses. The key 400 may be formed of metal, such as zinc, zinc alloy, or other suitable material. In this embodiment, the key 400 comprises a key barrel 401 and a key flag 402. The key barrel 401 may contain coding 406 (which may be formed by stamping) to cooperate with pins comprising a locking device located in a security head, and the key flag 402 may be grasped by a person during use.

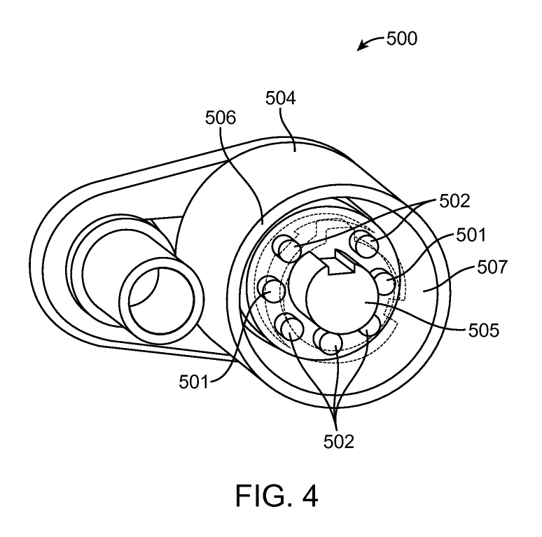

The key barrel 401 may be connected to the key flag 402 by at least one connecting rib 404. In the embodiment shown, a plurality of connecting ribs 404, comprising three separate connecting ribs, are used to connect the portions; however a greater number of, or fewer, ribs may be used. In certain embodiments, one or more of the ribs may have a thinner lateral dimension than other portions of the key (such that the ribs themselves may form a weaker material than other portions of the key flag or barrel). The key 400 may also contain at least one stress area 405 formed between the key barrel 401 and the key flag 402. In exemplary embodiments, the at least one stress area 405 can comprise a slot (e.g., a curved slot or a straight slot) formed between two connecting ribs 404. As used herein, a “stress area” can be area(s) of the key 400 where the connection between the key barrel 401 and the key flag 402 are weaker than other connecting areas. In the embodiment of FIG. 4, the at least one stress area 405 comprises two slots formed among the ribs 404. These slots can be holes extending through the width of the key body. More or less slots and ribs may be used in certain embodiments. In certain embodiments, a stress area may not comprise a through-slot, but may comprise a thinned area of the key. In some implementations, a stress area may comprise a weaker material than the surrounding areas of the key (e.g., a thinner material, a different material with lesser strength properties, etc.).

The at least one stress areas 405 allow the key 400 to be used with security apparatuses formed from a wide variety of lock materials. For example, zinc and zinc alloy are lightweight, strong, and relatively inexpensive materials. However, forming stabilizing elements (such as anti-rotation pins 311 shown in FIG. 2B) from zinc or zinc alloy could allow a user to break the stabilizing elements by inserting an improper key (such as a key configured for a different security apparatus), and rotating the key. If the improper key is formed of a metal stronger than zinc, the stabilizing elements may snap or otherwise become deformed.

The embodiments disclosed herein can overcome the above described issues. The locking head according to some embodiments of the invention may be smaller than prior art locks (e.g., the diameter may be less than the diameter of other locking heads), so that prior art keys will not fit within the space formed between housing and inner cylinder, as shown in FIG. 2A. Furthermore, embodiments of the invention provide for the at least one stress area 405 to be formed in the key 400, such that the key barrel 401 is configured to break away from the key flag 402 upon application of a minimum torque to the key. In certain implementations, the “minimum torque” can comprise the amount of torque applied to the key 400 upon rotation of the key 400 within a security apparatus other than an associated security apparatus. That is, a first key can be configured for use with a first security apparatus. This first key will not work with a second security apparatus (i.e., a security apparatus not associated with the first key). Inserting the first key into the second security apparatus, and turning as if to unlock the second security apparatus, can result in the key flag being separated from the key barrel of the first key. The first key can be designed and tuned to break before the second security apparatus breaks, due to the at least one stress area. Thus, an incorrect key will break, preventing the security apparatus from being twisted enough to either break the internal locking component or the housing of the portable article, as described in more detail below.

In certain embodiments, security systems can be manufactured for only two thirds the cost of some conventional systems, while still providing good security. As the head of the security apparatus is smaller than prior art locks, keys designed for such prior art locks will not fit within the opening of the security apparatus. Furthermore, the keys disclosed herein may be formed of die cast zinc and contain stress areas. A key according to an embodiment may comprise a diecast zinc alloy, such as Zamac #3. The key barrel 401 can be configured to break away from the key flag 402 upon application of a minimum torque to the key, as described above. In exemplary embodiments, the minimum torque can be the amount of torque applied to the key 400 upon rotation of the key 400 within an improper security apparatus (i.e., a security apparatus other than the associated apparatus that is configured for use with key 400). In one implementation, the minimum torque may comprise a range of 25-35 in·lbf or 25-30 in·lbf (such as 30 in·lbf). For example, the minimum torque can be about 25 in·lbf, or at least 25 in·lbf of torque. In another example, the minimum torque may comprise a range of about 22-28 in·lbf of torque. In certain implementations the minimum torque can be at least 35 in·lbf of torque, such as in the range of 35-45 in·lbf. Thus, in certain implementations, the key may comprise one connecting rib, which is configured to break when rotational pressure greater than or equal to 25 in·lbf is applied to the key flag while the key is inserted within the security apparatus (e.g., an unassociated security apparatus). In other implementations, the key may comprise more than one connecting rib (e.g. 2 connecting ribs, 3 connecting ribs, 4 connecting ribs, etc.) which may be so configured.

In certain embodiments, the minimum torque can be governed by the placement and shape of the at least one stress area 405 and the plurality of connecting ribs 404. In one embodiment, the plurality of connecting ribs 404 can comprise a first connecting rib 404a, a second connecting rib 404b, and a third connecting rib 404c, all formed equidistant from each other and connecting the key barrel 401 to the key flag 402. A first stress area 405a may be formed between the first connecting rib 404a and the second connecting rib 404b, and a second stress area 405b may be formed between the second connecting rib 404b and the third connecting rib 404c. This design may yield a minimum torque that is about 25 in·lbf, such as a torque in the range of 25-35 in·lbf.

FIG. 4 shows a view of the key end of a security apparatus according to an embodiment of the invention. In FIG. 4 the end portion of housing 506 (i.e., out portion 506) is not shown, in order to illustrate the inside of the locking head. The security apparatus can have an inner portion 505 and an outer portion 506 (e.g., a housing), which define a space 507. In certain implementations, all or portions of the outer portion can be covered by a rotatable sleeve 504. A plurality of pins 502 can be located in the space 507, and can comprise portions of a locking device within the security apparatus. The plurality of pins 502 is movable (in an axial direction) after a user inserts the proper key into the space 507 between the outer portion 506 and the inner portion 505. However, one or more fixed structures, such as pins 501, are not movable. Since the pins 501 are “fixed” and not movable, it is quite difficult to insert an unauthorized tubular structure such as the plastic barrel of a pen or other structure within the space, thereby inhibiting lock picking with the unauthorized tubular structure. Exemplary security apparatuses with fixed pins are described in U.S. Pat. No. 7,415,852, issued on Aug. 26, 2008, which is herein incorporated by reference in its entirety for all purposes. The authorized key that is used with the lock (e.g., the associated key) can have cutouts that would allow the key end to pass by the fixed pins 501. The fixed and movable pins, and the inner and outer portions of the lock may be made of the same or different material. For example, any of these components (e.g., any or all of the stabilizing elements, inner portion, outer portion, engagement element, etc.) may be made of a hard material such as zinc or a zinc alloy.

Although two stationary, non-movable pins 501 are shown, it is understood that any number of non-movable stationary pins can be used in other embodiments of the invention. For example, there can be only one non-movable pin 501 in between the inner portion 505 and the outer portion 506 in some embodiments. In other embodiments, there can be three or more non-movable pins (i.e., fixed structures) 501 between the inner portion 505 and the outer portion 506. In certain implementations, the non-movable pins (or other fixed structures) can be evenly spaced in the space 507 (e.g., a 12 and 6 o'clock positions; at 12, 3, 6, and 9 o'clock positions, etc.) so that an unauthorized barrel has a more difficult time pushing the movable pins 502 inwardly to thereby form an impression of the lock's key.

Other suitable fixed structures could be used in other embodiments of the invention. For example, instead of or in addition to fixed, non-movable pins, the fixed structures could be in the form of small rectangular blocks, which extend from the outer portion 506 or the inner portion 505. They could also extend from the outer portion 506 and the inner portion 505 in an alternating manner around the circular space 507. In yet another embodiment, the at least one fixed structure could be one or more “bridges” that bridge the space 507 in radial directions. In yet another embodiment, the at least one fixed structure could include a flange or other structure that could partially cover the space 507, so that the at least one fixed structure need not be directly between the inner portion 505 and the outer portion 506. In yet another embodiment, the fixed, non-movable structure could be an extension of the inner and/or outer portions of the lock. Such extensions could make the space 507 narrower at certain radial positions, thus impeding the passage of the end of a plastic barrel of a pen into the space 507.

Any of these fixed, non-movable structures would make it very difficult for one to insert an unauthorized tubular lock picking structure into the space 507. Combined with the rotatable sleeve 504 and the breakaway key design described herein, the fixed structures 501 provide for excellent security that is not easily defeated by either lock-picking or brute strength.

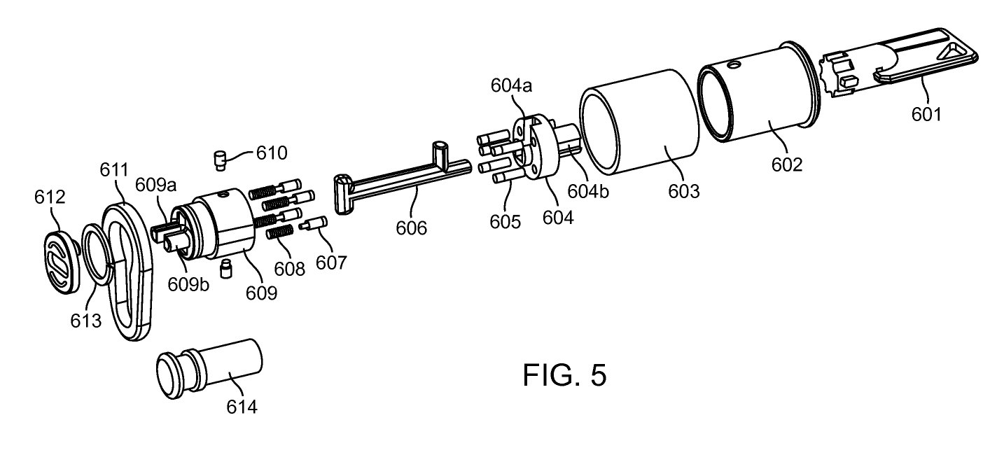

FIG. 5 shows an exploded view of a security apparatus 100, which is in the form of a radial lock according to an embodiment of the invention. The security apparatus 100 includes an “outer portion” comprising a housing (e.g., a lock body) 602. The housing 602 is hollow and physically coupled to a rear lock cylinder 609, by way of one or more pins 610. The rear lock cylinder 609 can also be coupled to a cable ring 611. The cable ring 611 may have an oval shape, such an oval with approximately only one axis of symmetry. In certain embodiments, the cable ring 611 may be located closer to the engagement element end (i.e., the first axial end) of the locking head than to the key end (e.g., the second axial end). Cable ring 611 can physically couple to a security device such as a cable (not shown), by way of a ferrule 614. Ferrule 614 is rotatably disposed within cable ring 611, such as within the smaller portion of cable ring 611, and can connect to the security device. This allows the security device to rotate relative to the head (as the cable ring 611 may be configured to freely rotate about the rear lock cylinder 609, and in turn the ferrule 614 may be configured to freely rotate within the cable ring 611) to allow for easy connection of the security device to an immovable object. Snap ring 613 is disposed between cable ring 611 and an exterior bumper 612. Bumper 612 can a soft material such as plastic or rubber, to prevent any damage to the portable article which is to be secured.

Two stabilizing elements 609a, 609b can be formed as part of the rear lock cylinder 609. In certain embodiments, one or more stabilizing elements 609a, 609b can be formed separately from the rear lock cylinder 609, and can be fixedly attached to the rear lock cylinder 609 such that the stabilizing elements 609a, 609b do not move relative to other parts of rear lock cylinder 609. An engagement element 606 is rotatably disposed within a passage in rear lock cylinder 609. The engagement element 606 may comprise a T-bar. The engagement element 606 can extend past the bumper 612 to engage with an aperture in a portable article (not shown) for locking. The engagement element 606 has a tab at one end that can align with a corresponding open region 604a (which can include a depression or a hole) in front lock cylinder 604. This allows the engagement element 606 and front lock cylinder 604 to rotate together.

Actual locking and unlocking action of the lock is brought about by the rotating motion of the front lock cylinder 604, which in turn causes the engagement element 606 to move between a locked and unlocked position. In certain embodiments, such rotation can be approximately 90 degrees. Rotational movement of the front lock cylinder 604 is normally effected by using an authorized tubular structure such as an associated key 601 that is adapted to fit into the opposing side of front lock cylinder 604 and having a tab which aligns with a keyway provided on the an inner portion 604b of front lock cylinder 604.

A series of angularly spaced driver pins 607 are slidably positioned within bores defined through the rear lock cylinder 609 and function to normally retain the front lock cylinder 604 in its locked position wherein rotational motion is prohibited. The driver pins 607 are invariably urged toward front lock cylinder 604 by means of coiled compression springs 608 disposed within the bores defined in the rear lock cylinder 609 which retain the driver pins 607.

Under the urging of the springs 608, the driver pins 607 are disposed along the bores in such a manner that the outer ends of the pins normally project outward beyond the shear plane formed at the interface of the rear lock cylinder 609 and the front lock cylinder 604, and into corresponding bores defined through the front lock cylinder 604. In this normal position, the driver pins 607 lock the front lock cylinder 604 and the engagement element 606 against rotational motion relative to rear lock cylinder 609, because at least some of the driver pins 607 lie across the shear plane.

The front lock cylinder 604 is rotatably supported within the front end of housing 602. A series of angularly spaced combination pins 605 are slidably positioned within bores defined in front lock cylinder 604 and function to receive the key 601. Alignment of all pins at the shear plane (which is the junction between front lock cylinder 604 and rear lock cylinder 609) displaces different combination pins 605 by different predetermined axial distances, due to the varying coding on the key 601. For example, a properly coded key 601 (e.g., a key associated with the locking apparatus) can displace the combination pins 605 predetermined axial distances in order to cause the rear ends of all of the combinating pins (the driver pins 607 and the combination pins 605) to be simultaneously aligned at the shear plane so that the front lock cylinder 604 may be rotated. In certain embodiments, combination pins 605 can be of approximately the same size as each other, and driver pins 607 can have varying lengths. In other embodiments, driver pins 607 can be of approximately the same size as each other, and combination pins 605 can have varying lengths.

Side pins 610 are inserted through apertures in housing 602 and through corresponding apertures in rear lock cylinder 609, to lock the rear lock cylinder 609 rotationally with respect to the housing 602. While rear lock cylinder 609 is rotationally locked with respect to housing 602, both are rotatable with respect to cable ring 611 (and thus rotatable with respect to a security device). With this structure, the fixed structures 609a, 609b can be rotationally locked with respect to the housing, while the engagement element 606 can rotate respectively, upon insertion and rotation of an associated key. A rotatable sleeve 603 can surround all, substantially all, or a portion of housing 602. In one embodiment, the rotatable sleeve may be located axially between the cable ring 611 and a key side lip of the housing 602. As described herein, the rotatable sleeve 603 may be configured to freely rotate about the housing 602. As very little of the housing 602 (e.g., just a small lip portion as illustrated in FIG. 5) may be left exposed by the rotatable sleeve 603, a user may not be able to manually twist the lock free from a secured portable article.

In certain embodiments, the key 601 can be inserted into the key end of a security apparatus (such as a lock) in order to lock and unlock the apparatus. If the key 601 is associated with the lock, the key can have the proper coding on the key barrel to displace the combinating pins 605, 607 located within the lock.

Security apparatuses like the ones described above, can be configured and/or used in any suitable manner. In some embodiments, the security apparatus only has one fixed stabilizing element along with an engagement element. The combined width of the engagement member and the stabilizing element is enough to prevent rotation within an aperture, such that the security apparatus is difficult to remove when in the locked state. In some embodiments, the engagement member can move (e.g., rotate) between a locked configuration and an unlocked configuration, while the first and second stabilizing elements remain in fixed positions. In other embodiments, the engagement member can remain stable and one or more stabilizing elements can extend into the aperture in the portable electronic device, after the engagement member is turned to a locked configuration (e.g., by rotating the entire head), to secure the security apparatus to the portable electronic device. To separate the security apparatus from the portable electronic device, the one or more stabilizing elements can be retracted. These embodiments can be used with a push button arrangement for moving the stabilizing elements. A suitable push button mechanism that can be used to cause movement of the stabilizing element(s) is in U.S. Pat. No. 6,591,642, which is herein incorporated by reference in its entirety.

Embodiments of the invention also include methods of use. Various method embodiments are apparent from the descriptions above. For example, security systems as disclosed herein may be used to secure portable articles. For example, a user can secure a portable article (such as a laptop or tablet computer) by inserting at least a portion of an engagement element of a security apparatus, as described above, into an aperture in the portable article, and securing the security apparatus to an immovable object by wrapping a cable attached to the head of the security apparatus around the object. Furthermore, a person may try to use their key to open another person's lock (i.e., break the other person's lock). The person can insert and rotate her key within her lock to lock or unlock her possessions. The person may also insert her key into another's lock. However, rotating her key in this lock will result in the key barrel becoming separated from the key flag. Embodiments disclosed herein show a lock comprising a t-bar engagement element used with a keyed lock. Other embodiments contemplate other engagement elements, such as attachment devices, other shaped bars, etc.

Another embodiment of a method of the invention includes obtaining a security apparatus having a housing, an engagement element extending out of a first side of the housing, and a rotatable sleeve surrounding at least a portion of the housing. The security apparatus can comprise a locking head as described herein. The method further includes inserting at least a portion of the engagement element into an aperture in a portable article, to secure the portable article. To lock the security apparatus to the portable article, the method further includes inserting a key into the security apparatus, the key having a key barrel, a key flag, and at least one stress area formed in the key between the key barrel and the key flag, and locking the security apparatus with the key.

A security apparatus, secured to a portable article as described above, will not be easily defeated by an unauthorized user. For example, in an embodiment of the invention, the security apparatus that is secured to the portable article can be a first security apparatus, and the key is a first key associated with this first security apparatus (i.e., the first key has coding that corresponds to the first locking head of the first security apparatus). The first security apparatus is secured by rotating the first key in the first security apparatus (to lock the locking head). A second security apparatus other than the first security apparatus, with a second associated key, can be secured to a different portable article. The second key can be associated with the second security apparatus (i.e., the second key has coding that corresponds to the second locking head of the second security apparatus). The first key and the second key can have different coding. The method of this embodiment further comprises removing the first key from the first security apparatus, inserting the key into the second security apparatus, and rotating the first key within the second security apparatus, such that the key barrel of the first key is separated from the key flag. Thus, the first key is broken, and the unauthorized user will not be able to twist the second security apparatus off of the portable article by using the first (unauthorized) key. The second security apparatus may also have a rotatable sleeve as described herein, to further prevent unauthorized removal.

Security systems as disclosed herein may be used to secure portable articles. For example, a user can secure a portable article (such as a laptop or tablet computer) by inserting at least a portion of an engagement element of a security apparatus, as described above, into an aperture in the portable article, and securing the security apparatus to an immovable object by wrapping a cable attached to the head of the security apparatus around the object. Furthermore, a person may try to use their key to open another person's lock (i.e., break the other person's lock). The person can insert and rotate his key within his lock to lock or unlock his possessions. The person may also insert his key into another's lock. However, rotating his key in this lock will result in the key barrel becoming separated from the key flag. Embodiments disclosed herein show a lock comprising a t-bar engagement element used with a keyed lock. Other embodiments contemplate other engagement elements, such as attachment devices, other shaped bars, etc.

Embodiments of security systems as described herein can provide good security and can be more compact, while being less expensive to produce. In an exemplary embodiment, the head of the security apparatus can be made smaller than conventional locks. Thus, conventional keys may not fit in the locking heads of security apparatuses according to embodiments of the invention. Further, the head of the security apparatus may also be surrounded by a rotatable sleeve, such as a slip ring. This can prevent a person from holding the head and twisting the apparatus while it is secured, in order to attempt to break the lock. Furthermore, keys according to embodiments of the invention may have a “breakaway” feature. With this breakaway feature, a key that inserted into the head of a non-corresponding security apparatus and subsequently turned, can break before the security apparatus is damaged. Such keys may have stress areas, rib connectors, or other suitable breakaway features.

The above described features may work together to allow for enhanced security at lower cost. For example, the keys and stabilizing elements may comprise zinc or a zinc alloy. In conventional locks, a user could twist the lock, by hand or by using an improperly coded key, to break certain lock features (such as stabilizing elements). The conventional lock could be easily removed from the portable article once the stabilizing elements are broken. In embodiments disclosed herein, a user may not be able to twist the lock with sufficient force to break the stabilizing elements.

### EXAMPLES

### Example 1

### Locking Head Strength

The rotational strength of samples of the locking head of the type shown in FIG. 1 were evaluated, by securing the samples to a substantially rectangular slot in a metal plate and rotating the locking heads until one or more stabilizing elements in each locking head broke. Five samples were subjected to a rotational force. Each sample had two stabilizing elements comprising anti-rotation pins formed of Zinc. The average torque required to break at least one stabilizing element was 32 in-lbs.

TABLE 1

| | Torque Required To Break a Stabilizing |
|---|---|
| Sample | Element (in-lbs) |
| 1 | 30.0 |
| 2 | 30.0 |
| 3 | 30.0 |
| 4 | 35.0 |
| 5 | 35.0 |
| Average | 32.0 |

As seen in the Example 1, a user would need to twist a locking head with a force greater than 30 or 35 in-lbs to snap a stabilizing element off and remove the security apparatus from the locked portable article. However, embodiments described herein provide for a rotatable sleeve surrounding all or substantially all of the housing of the locking head. A user will not be able to apply torque greater than 30 in-lbs to the locks of these embodiments, as attempting to forcibly rotate the heads will only result in the rotation of the rotatable sleeve. The stabilizing elements of these locking heads will not be rotated, preventing failure and potential theft.

### Example 2

### Key Strength

The rotational strength of a key of the type shown in FIG. 3A securely clamped in place was evaluated. Fourteen samples were subjected to a rotational force. The key samples each comprised zinc. The average torque required to break the key along the stress area (i.e., for the connecting ribs to snap) was about 17 lbs.

TABLE 2

| Sample | Torque Required To Break Key (in-lbs) |
|---|---|
| 1 | 12.0 |
| 2 | 15.0 |
| 3 | 18.0 |
| 4 | 20.0 |
| 5 | 15.0 |
| 6 | 15.0 |
| 7 | 15.0 |
| 8 | 15.0 |
| 9 | 15.0 |
| 10 | 18.0 |
| 11 | 18.0 |
| 12 | 18.0 |
| 13 | 19.0 |
| 14 | 20.0 |
| Average | 16.6 |

Many implementations of keys have a torque strength of about 20 in-lbs. Compared with the locking head of Example 1, above, the embodiments of the key in Example 2 will break with a lower applied torque (between 15 in-lbf and 20 in-lbf). Thus, the key will break before the stabilizing elements of the locking head. Embodiments of the locking heads disclosed herein are able to be economically produced with stabilizing elements that will shear off between 30 in-lbf and 35 in-lbf. Embodiments of the key are designed to fail before the locking head, so that a user could not use an incorrect key (i.e., a key not associated with the locking head) as a tool to snap off the stabilizing elements and defeat the system.

An average person can apply about 20 in-lbf to 25 in-lbf of torque to a typical key. This is below the fail point of embodiments of the stabilizing elements (approximately 30 in-lbf in Example 1), so that a key would not be usable to break a security apparatus by an average person. However, even an exceptionally strong person would be unable to use embodiments of the keys disclosed herein, as such keys are designed to snap prior to the failure of such locking heads.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed.

Moreover, any one or more features of any embodiment of the invention may be combined with any one or more other features of any other embodiment of the invention, without departing from the scope of the invention.

All patent applications, patents, and publications mentioned above are herein incorporated by reference in their entirety for all purposes. None is admitted to be prior art.

What is claimed is:

1. A security system comprising:
a security apparatus having
a housing, and
an engagement element extending out of a first side of the housing; and
a key configured to lock the security apparatus, the key having
a key barrel,
a key flag, and
at least one stress area formed in the key between the key barrel and the key flag.

2. The security system of claim 1, wherein the key comprises at least one connecting rib connecting the key barrel to the key flag.

3. The security system of claim 2, wherein the at least one stress area comprises a slot formed between a first connecting rib and a second connecting rib, wherein the first connecting rib and second connecting rib connect the key barrel to the key flag.

4. The security system of claim 2, wherein the key is configured to be inserted within the security apparatus, further wherein the at least one connecting rib is configured to break when rotational pressure greater than or equal to 25 in·lbf is applied to the key flag while the key is inserted within the security apparatus.

5. The security system of claim 1, wherein the security apparatus further comprises a rotatable sleeve around at least a portion of the housing.

6. The system of claim 1, wherein the housing comprises an outer portion of the security apparatus, the security apparatus further comprising:
an inner portion;
a plurality of movable pins disposed between the outer portion and the inner portion, and being accessible through a space formed by the outer portion and the inner portion; and
at least one fixed structure inhibiting passage of an unauthorized tubular structure into the space.

7. The system of claim 1, wherein the engagement element comprises a T-bar, the security apparatus further comprising at least one stabilizing element extending from the first side of the housing.

8. The system of claim 7, wherein the at least one stabilizing element comprises a zinc alloy.

9. A key for locking and unlocking an associated security apparatus, the key having a key body comprising:
a key barrel;
a key flag; and
at least one stress area formed in the key such that the key barrel is configured to break away from the key flag upon application of a minimum torque to the key.

10. The key of claim 9, wherein the minimum torque comprises the amount of torque applied to the key upon rotation of the key within a security apparatus other than the associated security apparatus.

11. The key of claim 9, wherein the minimum torque comprises at least 25 in·lbf.

12. The key of claim 9, further comprising a plurality of connecting ribs connecting the key barrel to the key flag, wherein the at least one stress area is formed between a first connecting rib and a second connecting rib.

13. The key of claim 12, wherein the plurality of connecting ribs comprises a third connecting rib, the first, second, and third connecting rib being formed equidistant from each other, the key further comprising a second stress area formed between the second connecting rib and the third connecting rib.

14. The key of claim 12, wherein each rib in the plurality of connecting ribs is formed of zinc or zinc alloy.

15. The key of claim 9, wherein the at least one stress area comprises a slot formed between the key barrel and the key flag.

16. A method of securing a portable article, comprising:
obtaining a security apparatus having a housing, and an engagement element extending out of a first side of the housing;
inserting at least a portion of the engagement element into an aperture in a portable article;
inserting a key into the security apparatus, the key having a key barrel, a key flag, and at least one stress area formed in the key between the key barrel and the key flag; and
locking the security apparatus with the key.

17. The method of claim 16, wherein the security apparatus comprises a first security apparatus, the key associated with the first security apparatus, and the locking the security apparatus with the key includes rotating the key to lock the first security apparatus, the method further comprising:
removing the key from the first security apparatus;
inserting the key into a second security apparatus other than the first security apparatus; and
rotating the key within the second security apparatus, such that the key barrel is separated from the key flag.

18. The method of claim 17, wherein the second security apparatus is not associated with the key.

19. The method of claim 17, wherein the security apparatus has a rotatable sleeve surrounding at least a portion of the housing.

20. The method of claim 19, further comprising rotating the rotatable sleeve without rotating the housing.
